(19) United States
(12) Patent Application Publication
(10) Pub. No.: US 2009/0101633 A1
(43) Pub. Date: Apr. 23, 2009

(54) REACTOR WITH SMALL LINEAR LAMPS FOR LOCALIZED HEAT CONTROL AND IMPROVED TEMPERATURE UNIFORMITY

(75) Inventors: Ravinder Aggarwal, Gilbert, AZ (US); Jeroen Stoutjesdijk, Bussum (NL); Paul Jacobson, Phoenix, AZ (US)

Correspondence Address: Knobbe, Martens, Olson & Bear LLP, 2040 Main Street, 14th Floor, Irvine, CA, 92614, US

(73) Assignee: ASM AMERICA, INC., Phoenix, AZ (US)

(21) Appl. No.: 11/875,259

(22) Filed: Oct. 19, 2007

(51) Int. Cl. F27D 11/00

(52) U.S. Cl. 219/385

(57) ABSTRACT

An arrangement of short linear heat lamps is provided which allows for localized control of temperature nonuniformities in a substrate during semiconductor processing. A reactor includes a substrate holder positioned between a top bank and a bottom bank of linear heat lamps. Alternatively, only one such bank may be provided. At least one of the banks includes lamps of a plurality of different lengths, at least some of the lengths being shorter than a diameter of the substrate holder. In some configurations, the lamps in a bank are disposed substantially parallel to each other in a repeating pattern. In some other configurations, the lamps in a bank are disposed in a radial direction with respect to a vertical axis of the substrate holder. Power output of the short lamps can be adjusted individually or in groups to provide localized control of temperature of the substrate.

### BACKGROUND

1. Field of the Invention

The invention generally relates to semiconductor processing equipment. More particularly, this invention relates to apparatuses for heating semiconductor substrates.

2. Description of the Related Art

In semiconductor processing, a variety of processes—including deposition, etching, and masking—involve heating of substrates. Chemical vapor deposition (CVD), for example, is a very well known process for forming thin films of materials on substrates, such as silicon wafers. In a CVD process, gaseous molecules of the material to be deposited are supplied to wafers to form a thin film of that material on the wafers by chemical reaction. Such formed thin films may be polycrystalline, amorphous or epitaxial. Typically, CVD processes are conducted at elevated temperatures to accelerate the chemical reaction and to produce high quality films. Some processes, such as epitaxial silicon deposition, are conducted at extremely high temperatures (>500° C., <1220° C.).

During a CVD process, one or more substrates are placed on a substrate support inside a reaction chamber defined within the reactor. For example, the substrate can be a wafer and the substrate support can be a susceptor. Both the substrate and often the support are heated to a desired temperature. In a typical wafer treatment step, reactant gases are passed over the heated wafer, causing chemical vapor deposition (CVD) of a thin layer of the desired material on the wafer. If the deposited layer has the same crystallographic structure as the underlying silicon wafer, it is called an epitaxial layer. This is also sometimes called a monocrystalline layer because it has only one crystal structure. Through subsequent processes, these layers are made into integrated circuits, producing from tens to thousands or even millions of integrated devices, depending on the size of the wafer and the complexity of the circuits.

Various process parameters must be carefully controlled to ensure a high quality of layers produced in semiconductor processing. One critical parameter is the temperature of the wafer during each treatment step of wafer processing. During CVD, for example, the wafer temperature dictates the rate of material deposition on the wafer because the deposition gases react at particular temperatures and deposit on the wafer. If the temperature varies across the surface of the wafer, uneven deposition of the film occurs and the physical properties will not be uniform over the wafer. Furthermore, in epitaxial deposition, even slight temperature nonuniformity can result in crystallographic slip.

### SUMMARY

In accordance with one embodiment, a semiconductor apparatus comprises a substantially circular substrate holder configured to support a semiconductor substrate during semiconductor processing, and a plurality of linear heat lamps. The entire plurality of heat lamps is positioned either above or below the substrate holder. The lamps have a plurality of different lengths, each length being shorter than a diameter of the substrate holder.

In another embodiment, a semiconductor apparatus comprises a substrate holder configured to support a semiconductor substrate during semiconductor processing, and a plurality of linear heat lamps. The plurality of heat lamps is positioned either above or below the substrate holder. Each lamp in the plurality has approximately a first, second, or third length. The second length is between 40% and 60% of the first length, and the third length is between 15% and 35% of the first length.

Another embodiment involves an array of heat lamps for providing radiant heat to a substrate being processed. The array comprises a first set of linear lamps each having approximately a first length, a second set of linear lamps each having approximately a second length that is between 40-60% of the first length, and a third set of linear lamps each having approximately a third length that is between 15-35% of the first length.

A further embodiment includes a method comprising providing a substantially circular substrate holder configured to support a semiconductor substrate during semiconductor processing, providing a plurality of linear heat lamps of a plurality of different lengths, and positioning the entire plurality of lamps either above or below the substrate holder. Each of the lengths is shorter than a diameter of the substrate holder.

In yet another embodiment, a method comprises providing a substrate holder configured to support a semiconductor substrate during semiconductor processing, providing a plurality of linear heat lamps, and positioning the plurality of lamps either above or below the substrate holder. Each lamp has approximately a first, second, or third length, the second length being less than 60% of the first length, and the third length being less than 60% of the second length.

In still another embodiment, a method comprises providing a first set of linear heat lamps each having approximately a first length. A second set of linear heat lamps is provided, each having approximately a second length that is between 40-60% of the first length. A third set of linear heat lamps is provided, each having approximately a third length that is between 15-35% of the first length. The first, second, and third sets of lamps are arranged together in an arrangement to provide radiant heat to a substrate.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the present invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1A is a cross-sectional view of a conventional reaction chamber along with a top bank and a bottom bank of heat lamps, the chamber having a substrate supported on a substrate holder therein;

FIG. 1B is a top plan view of a conventional substrate holder;

FIG. 1C is a partial cross-sectional view of the substrate holder of FIG. 1B, taken along line 1C-1C of FIG. 1B.

FIG. 1D is a partial cross-sectional view of the substrate holder of FIGS. 1B and 1C, shown with a substrate held thereon.

FIGS. 2A and 2B are schematic top (2A) and bottom (2B) plan views showing a conventional arrangement of lamps in a top bank (2A) and a bottom bank (2B) of a reactor.

FIGS. 3A and 3B are schematic top (3A) and bottom (3B) plan views showing an arrangement of lamps in a top bank (3A) and a bottom bank (3B) of a reactor, according to an embodiment of the present invention.

FIGS. 4A and 4B are schematic top (4A) and bottom (4B) plan views showing an alternative arrangement of lamps in a top bank (4A) and bottom bank (4B) of a reactor, according to another embodiment of the present invention.

FIGS. 5A and 5B are schematic top (5A) and bottom (5B) plan views showing another alternative arrangement of lamps in a top bank (5A) and bottom bank (5B) of a reactor, according to another embodiment of the present invention.

FIGS. 6A and 6B are schematic top (6A) and bottom (6B) plan views showing a further alternative arrangement of lamps in a top bank (6A) and bottom bank (6B) of a reactor, according to another embodiment of the present invention.

### DETAILED DESCRIPTION OF THE PREFERRED EMBODIMENTS

Reactors used in semiconductor processing, including CVD reactors, typically employ radiant heat lamps positioned around a reaction chamber to achieve the desired high temperatures in the substrate. Unfortunately, radiant energy has a tendency to create nonuniform temperature distributions, including “hot spots,” due to the use of localized radiant energy sources and consequent focusing and interference effects. The increased surface area of the substrate and the substrate holder near their outer edges also leads to convective heat loss, resulting in further temperature nonuniformities. Still other temperature nonuniformities can result from heat loss to the spider supporting the substrate, or from heat loss caused by the use of sweep gas underneath the substrate. Temperature nonuniformities result in undesirable processing nonuniformities in the wafer, such as variations in thickness of deposited films and variations in resistivity.

To promote uniform temperature of the substrate during processing, some reactors include lamps which are grouped in separately controllable heating zones, allowing differing levels of power to be supplied to each individual zone. Other reactors include segmented lamps having differing filament winding densities along the length of the lamp, such that power output along the length of each lamp differs. Such zoned heating apparatuses are described in further detail in U.S. Pat. No. 6,465,761.

In order to correct a temperature nonuniformity in a particular region of the substrate, however, these and other conventional systems require the power to an entire lamp to be adjusted. As conventional systems use long lamps which span at least the diameter of the substrate, this leads to nonuniform temperature in other parts of the substrate. The resulting nonuniformities must then be compensated for by adjusting power to other lamps, making it very difficult to create uniform temperature throughout the substrate.

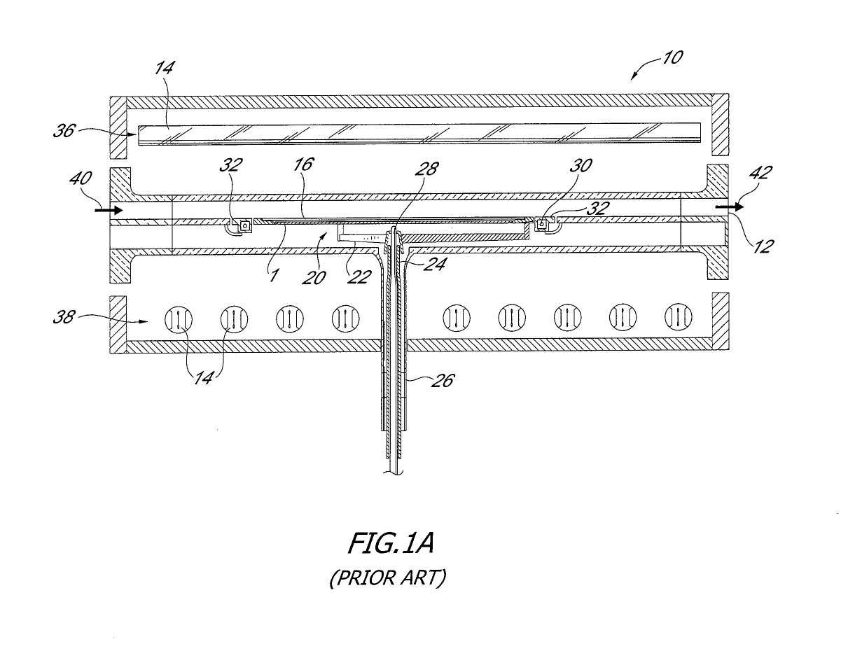

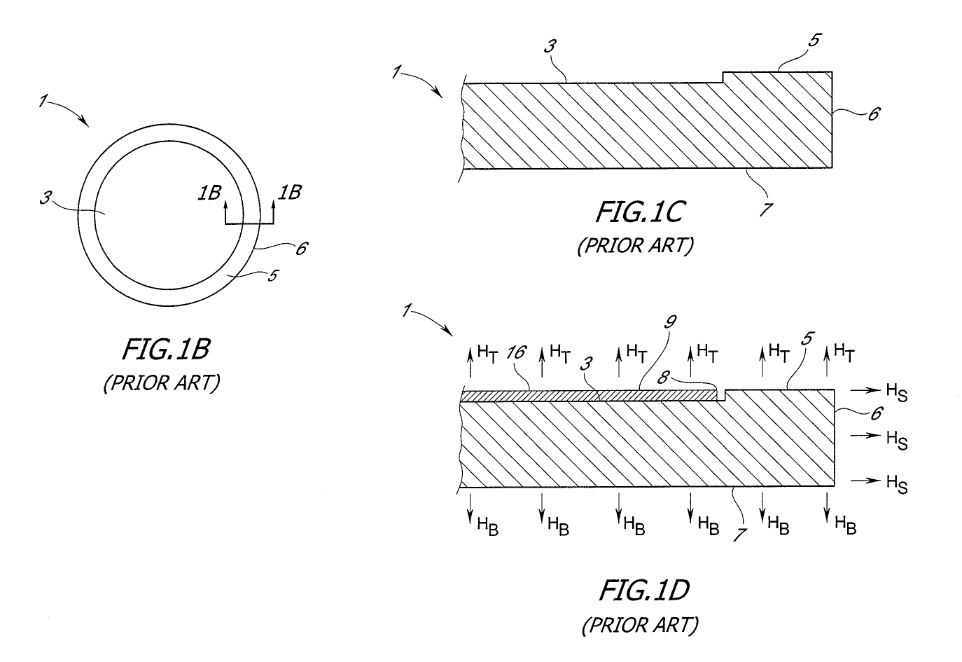

Thus, embodiments of the present invention desirably provide a lamp system allowing for localized control of radiant heat output in a semiconductor reactor. FIGS. 1A-1D show a conventional reactor 10 commonly used and known in the industry for CVD processing, in which embodiments of the invention may be practiced. As can be seen in FIG. 1A, the reactor 10 includes a reaction chamber 12 of the horizontal flow type formed of a material transparent to heat energy, such as quartz. Gas flows into and out of the chamber 12 in the direction indicated by arrows 40 (inlet) and 42 (outlet).

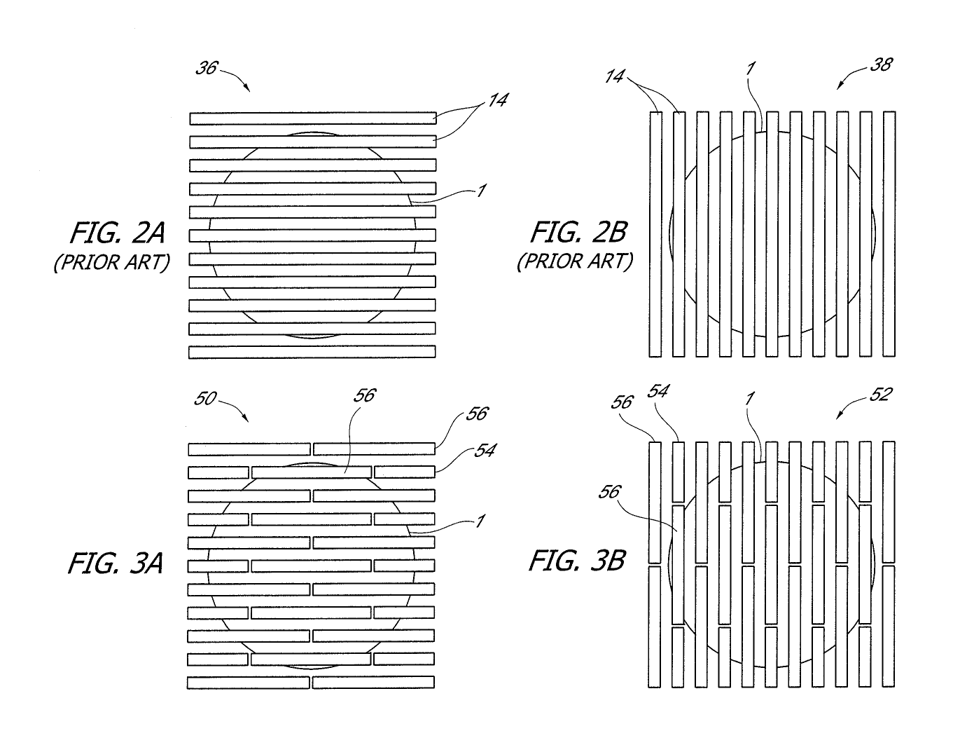

The reactor 10 is shown with a conventional arrangement of heating lamps 14 (described in further detail below in connection with FIGS. 2A and 2B), disposed in a top bank 36 above and a bottom bank 38 below the chamber 12. Banks 36 and 38 are supported outside the chamber 12 to provide heat energy to the chamber 12 without appreciable absorption by the chamber walls. The reactor 10 includes a substrate support structure 20 comprising a substrate holder 1, upon which a semiconductor substrate 16 may rest, and a spider 22 that supports the holder 1. The spider 22 may be made of a transparent material. The material may also be non-metallic to reduce the risk of contamination. The spider 22 is mounted to a shaft 24, which extends downwardly through a tube 26 depending from the lower wall of the chamber 12. The shaft 24, spider 22, and holder 1 are configured to be rotated in unison about a vertical center axis of the holder 1 during substrate processing.

FIGS. 1B-1D further illustrate the exemplary substrate holder 1 of the reactor 10. The holder 1 has a generally circular shape and includes a pocket 3 configured to receive the substrate 16. During substrate processing, the substrate holder 1 may absorb heat from the radiant heat lamps 14 (FIG. 1A) surrounding the reaction chamber 12. The substrate holder 1 also loses heat to the surrounding environment (e.g., to the chamber walls, which typically are not perfectly reflective). Some of this heat may be re-radiated from the holder 1, while the rest is lost by convection and conduction. With reference to FIG. 1D, the holder 1 loses heat from its upper surfaces 3 and 5, side surface 6, and bottom surface 7, and the substrate 16 loses heat from its upper surface 9 and its edge 8. The arrows H_{T} schematically illustrate the heat lost at the upper surfaces 3, 5, and 9. Similarly, the arrows H_{S} and H_{B} schematically illustrate the heat loss at the side surface 6 and the bottom surface 7, respectively. Throughout most of the holder/substrate combination, the heat loss H_{T} and H_{B} is typically counterbalanced with uniform heat input from the lamps 14 across the combination surface. However, there is additional heat loss H_{S} at the outer radial edge of the holder/substrate combination, which receives less direct radiation. This results in a lower temperature at the outer radial edge of the holder 1 and substrate 16. The additional heat loss at the edge induces temperature gradients from the wafer center to the edge, as heat flows in that direction. Furthermore, localized temperature nonuniformities can also result from conductive heat loss to the spider 22 or from convective heat loss from the introduction of sweep gas through holes in the substrate holder 1 underneath the substrate 16.

Without localized control of power output to the heat lamps 14, these temperature nonuniformities are either undercompensated or overcompensated. Consequently, the conventional lamp design normally results in some degree of processing nonuniformities in the processed wafer, which can render some portions of the wafer unusable. For example, the area near the outer radial edge 8 of the substrate 16 is commonly referred to as an “exclusion zone,” because this area cannot be used to fabricate satisfactory chips.

Referring once again to FIG. 1A, the exemplary reactor 10 includes a central temperature sensor or thermocouple 28 extending through the shaft 24 and the spider 22 in proximity to the substrate holder 1. Additional peripheral thermocouples 30 may also be housed within a slip ring or temperature compensation ring 32, which may surround the substrate holder 1 and the substrate 16. The thermocouples 28, 30 may be connected to a temperature controller (not shown), which may selectively set the power of the various heating elements 14 in response to the readings of the thermocouples 28, 30.

With reference now to FIGS. 2A and 2B, the conventional arrangement of heating lamps 14 is further illustrated. The arrangement includes long lamps 14 which span at least the diameter of the substrate holder 1. As shown in the figures, the lamps 14 in the top bank 36 are arranged parallel to each other and perpendicular to the lamps 14 in the bottom bank 38. While FIG. 1A shows the top bank 36 having lamps 14 oriented parallel to the direction of gas flowing through the chamber 12, and the bottom bank 38 having lamps 14 oriented perpendicular to the direction of gas flow, it is generally understood that these orientations can be reversed. That is, the top bank 36 can be perpendicular to the direction of gas flowing through the chamber 12, and the bottom bank 38 can be parallel to the direction of gas flowing through the chamber 12. Alternatively, both banks 36, 38 can be oriented in the same direction.

Although the lamps 14 are disposed in a uniform pattern, temperature nonuniformities still occur in the substrate, as discussed above in connection with FIGS. 1B-1D. The conventional arrangement of long lamps 14 makes localized control of temperature difficult, because power to an entire lamp 14 must be adjusted in order to address a local nonuniformity. Another disadvantage of the conventional arrangement of long lamps 14 is that, because of their length, the lamp filaments are susceptible to sag, which increases the risk of lamp failure.

Against this background, aspects and advantages of the present invention will now be described with reference to the drawings of several preferred embodiments, which embodiments are intended to illustrate and not to limit the invention.

Referring now to FIGS. 3A and 3B, an arrangement of heat lamps according to an embodiment of the invention is illustrated. The illustrated embodiment may include a top bank 50 and a bottom bank 52 of linear heat lamps 54, 56 which are each shorter than the diameter of the substantially circular substrate holder 1. The lamps 54, 56 may also be shorter than the diameter of the pocket 3. The lamps 56 may, for example, be approximately half the diameter of the substrate holder 1; the lamps 54 may be approximately half the length of the lamps 56. As illustrated in the figure, the lamps 54, 56 in each bank 50, 52 may be arranged in a repeating pattern of substantially parallel rows. The lamps 54, 56 need not be arranged collinearly; instead, they may instead be laterally or vertically offset from one another. Additionally, the lamps need not be arranged parallel to one another; rather, they may be disposed askew to one another, depending on the requirements of the particular application. The lamps 54, 56 of the top bank 50 may further be positioned so as to be substantially perpendicular to the lamps 54, 56 of the bottom bank 52. The lamps 54, 56 in the top bank 50 may be suspended from, or attached to, a ceiling plate or framework (not shown) mounted in the reactor 10. Similarly, the lamps 54, 56 in the bottom bank may be attached to a floorplate or framework (not shown) mounted in the reactor 10.

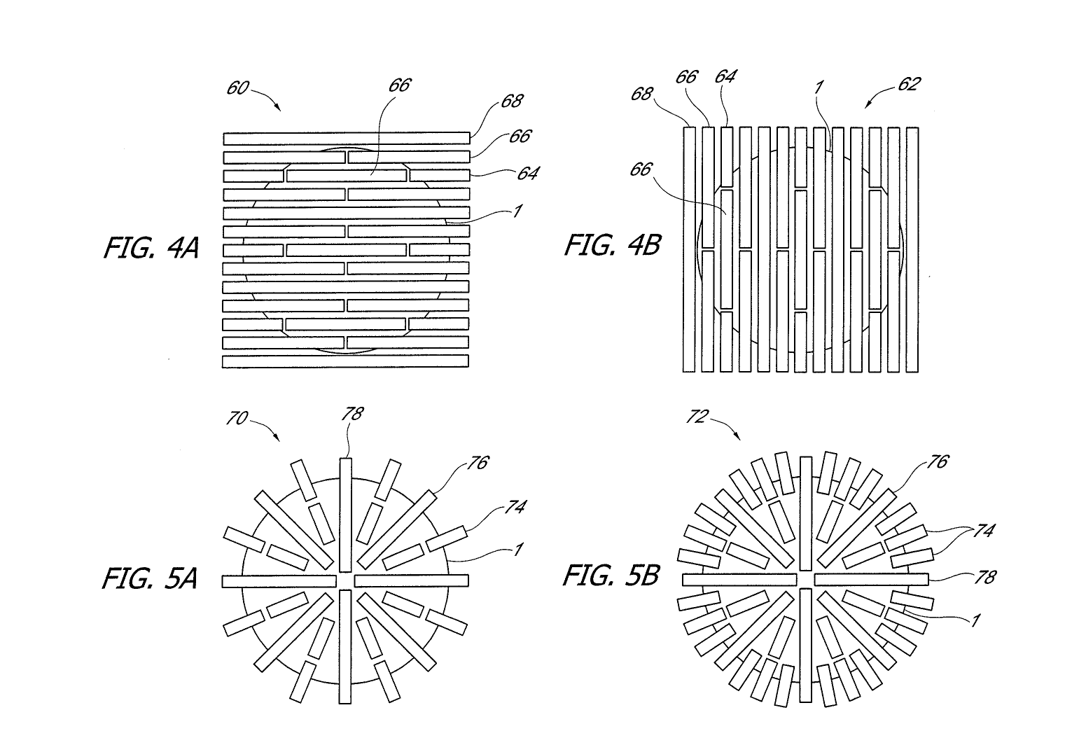

FIGS. 4A and 4B illustrate another embodiment of the invention which includes a top bank 60 and a bottom bank 62 of linear heat lamps 64, 66, and 68. The lamps 68 may be approximately the same length as the diameter of the substrate holder 1. The lamps 68 may alternatively be longer or shorter than the diameter of the substrate holder 1. The lamps 66 may be approximately half the length of the lamps 68, and the lamps 64 may be approximately half the length of the lamps 66. Embodiments may of course include lamps having other relative lengths; for example, embodiments may include two or more sets of lamps, each set having an approximate length less than 60% of the next set's length. Alternatively, a bank of lamps may include lamps having three different lengths, the second length being between 40-60% of the first length and the third length being between 15-35% of the first length. Further, the second set of lamps can each have an approximate length within a certain percentage range of the length of the first set of lamps, said range being, for example, 40-60%, 45-55%, or 48-52%. Likewise, the third set of lamps can each have an approximate length within a smaller percentage range of the length of the first set of lamps, said range being, for example, 20-30% or 23-27%. As illustrated in the figure, the lamps 64, 66, and 68 in each bank 60, 62 may be arranged in a repeating pattern of substantially parallel rows. The lamps 64, 66, and 68 need not be arranged collinearly, however; they may instead be laterally or vertically offset from one another. The lamps 64, 66, 68 of the top bank 60 may further be positioned so as to be substantially perpendicular to the lamps 64, 66, 68 of the bottom bank 62.

As illustrated in FIGS. 5A and 5B, yet another embodiment of the invention includes a top bank 70 and a bottom bank 72 of lamps 74, 76, and 78 arranged in a substantially radial direction about a central vertical axis of the substrate holder 1. The lamps 74, 76, and 78 may each be shorter than the diameter of the substrate holder 1. Although illustrated with a length approximately 60% of the diameter of the substrate holder, the lamps 78 may have any length shorter than the diameter of the substrate holder. The lamps 76 may be shorter than the lamps 78, and the lamps 74 may be shorter than the lamps 76. As shown in FIG. 5B, more short lamps 74 can be provided near the outer edge of the substrate holder 1 (in either or both of the banks 70, 72), to allow for greater localized temperature control near the outer edge of the substrate 16 (FIG. 1A, 1D) where convective heat loss is more likely to occur. The lamps 74, 76, and 78 need not all be disposed radially, but may be arranged in any manner suitable to allow for localized heat control where such control is desirable. Thus, embodiments of the invention may include top and bottom banks of lamps having either the same or different lamp patterns. The lamps 74, 76, and 78 may further be arranged so as to allow passage of the substrate support structure 22 and tube 26 (FIG. 1A) through the bottom bank 72.

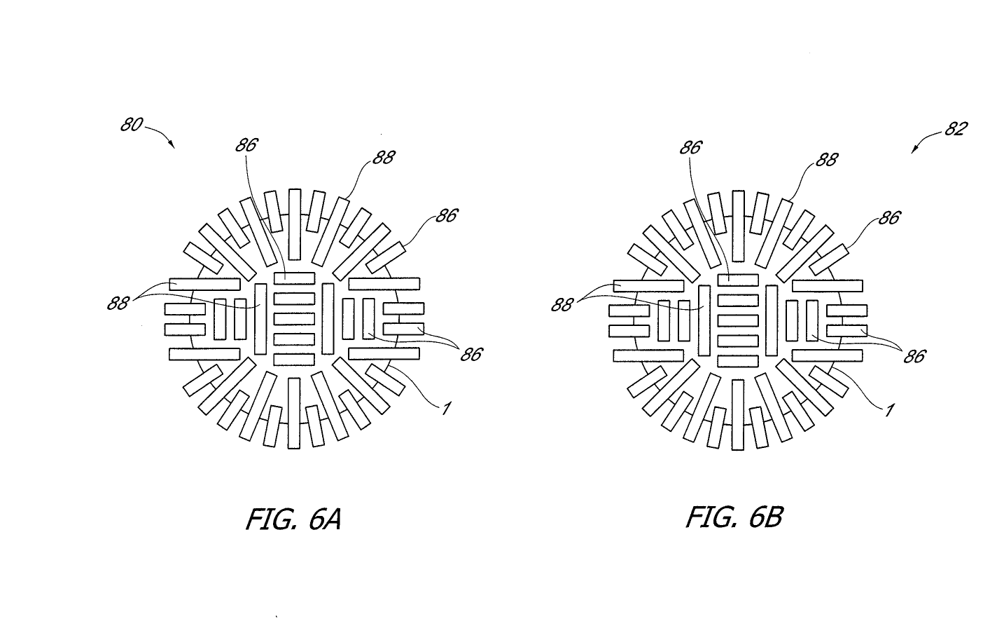

With reference now to FIGS. 6A and 6B, a still further embodiment of the invention includes a top bank 80 of lamps 88, 86 disposed above a substrate holder 1. Each lamp 88 may be shorter than a diameter of the substrate holder 1 and each lamp 86 may be shorter than each lamp 88. Some of the lamps 88, 86 may be disposed in a substantially radial direction about a central vertical axis of the substrate holder 1. Other lamps 88, 86 may be disposed parallel and/or perpendicular to each other. As shown in the figures, some of the lamps 88, 86 may be disposed entirely above the substrate holder 1, while others may extend from above the substrate holder 1 to beyond its outer edge. The lamps 88, 86 of the top bank 80 may be disposed in a single plane parallel to the plane of the substrate holder 1, in one or more planes parallel to the plane of the substrate holder 1, or at one or more angles relative to the substrate holder 1. The illustrated embodiment may also include a bottom bank 82 of lamps 88, 86 disposed in a similar pattern to the top bank 80. For example, some of the lamps 88, 86 may be disposed entirely below the substrate holder 1, while others may extend from below the substrate holder 1 to beyond its outer edge. Alternatively, embodiments may include a bottom bank of lamps disposed in a different pattern than that of the top bank. Of course, embodiments of the invention, such as a top bank according to an embodiment, may also be used in combination with conventional lamp arrangements, such as a conventional bottom bank.

As will be understood by one of skill in the art, providing more, shorter lamps desirably allows for control of incident power over smaller portions of a substrate, allowing temperature adjustment over a smaller area without affecting temperature over an adjoining area. In advantageous embodiments of the invention, shorter lamps can be strategically placed to cover certain areas of the substrate where temperature nonuniformity issues need to be resolved.

Another advantage of these and other embodiments including more, shorter lamps is that the desired high temperatures in the substrate can be achieved by operating most of the lamps in a lower power output range than with the conventional arrangement of long lamps. Providing more, shorter lamps thus avoids unnecessary stress on the lamps, thereby prolonging lamp life and reducing the risk of lamp failures due to overheating. Yet another advantage of providing more, shorter lamps instead of fewer, longer lamps is that filaments of shorter lamps are less susceptible to sag. Thus, these and other embodiments desirably reduce lamp failures.

Accordingly, these and other inventive lamp arrangements can be used in an advantageous method to provide improved temperature uniformity across a substrate during processing. The method can involve arranging a plurality of heat lamps above and/or below a substrate holder to allow for localized control of heat output in a reactor. A plurality of linear heat lamps of a plurality of different lengths may be provided, each of the lengths being shorter than a diameter of the substrate holder. Lamps of the same wattage or of differing wattages can be used. The lamps may be positioned above and/or below the substrate holder in locations where temperature nonuniformities may occur or where localized control of temperature is otherwise desirable. The lamps may be arranged, for example and without limitation, in a direction generally parallel to one another, generally perpendicular to one another, generally radially with respect to the substrate holder, or in any combination of the above. The power to each set of lamps, or to each individual lamp, may be varied in order to achieve a substantially uniform temperature throughout a substrate during processing.

A bank of lamps may be disposed above the substrate, and/or a bank of lamps may be disposed below the substrate. Optionally, each bank of lamps may be oriented substantially within a single plane that is either generally parallel with respect to the substrate and/or substrate holder, or at an angle with respect to the substrate and/or substrate holder. Additionally, some lamps may be arranged closer to the substrate holder than others, in one or more planes. Some lamps may be disposed at varying angles with respect to the substrate and/or substrate holder. Some lamps may also be arranged closer together than others, to allow for finer temperature control in particular areas. The lamps may further be arranged in any other configuration suitable for addressing temperature nonuniformities that may occur during substrate processing, such as those discussed above in connection with FIGS. 1A-1D. For example, as discussed above, more, shorter lamps may be provided near the outer perimeter of the substrate holder to address heat loss which occurs near the edge of the substrate holder. Using these and other advantageous methods, the temperature gradients within a reactor, and therefore across the substrate, can be greatly reduced and the uniformity of the product (and thus the product yield) can be improved. It should be noted that the existence of temperature nonuniformities in a reactor can be determined in any suitable manner, including but not limited to, direct temperature measurements of the substrate holder 1 (for example, with thermocouples or pyrometers).

Skilled artisans will appreciate that the claimed embodiments are not limited to use within the particular reactor 10 disclosed herein. In particular, one of skill in the art can find application for the lamp arrangements described herein for other semiconductor processing equipment, wherein a substrate is desirably heated to a uniform temperature, particularly where the support is subject to edge losses near the substrate edge. Moreover, while illustrated in the context of standard silicon wafers, the lamp arrangements described herein can be used to provide localized heat control in a variety of other applications.

It will also be understood by those of skill in the art that numerous and various modifications can be made without departing from the spirit of the present invention. Therefore, it should be clearly understood that the forms of the invention described herein are illustrative only and are not intended to limit the scope of the invention.

1. A semiconductor apparatus comprising:
a substantially circular substrate holder configured to support a semiconductor substrate during semiconductor processing;
a plurality of linear heat lamps, the entire plurality being positioned either above or below the substrate holder, the lamps having a plurality of different lengths, each length being shorter than a diameter of the substrate holder.

2. The semiconductor apparatus of claim 1, wherein the plurality of different lengths comprises at least a first and second length, the second length being less than 60% of the first length.

3. The semiconductor apparatus of claim 2, wherein the plurality of different lengths further comprises a third length, the third length being less than 60% of the second length.

4. The semiconductor apparatus of claim 3, wherein the second length is approximately half of the first length and the third length is approximately half the second length.

5. The semiconductor apparatus of claim 1, wherein at least some of the plurality of linear heat lamps are disposed radially with respect to a vertical axis of the substrate holder.

6-7. (canceled)

8. The semiconductor apparatus of claim 1, wherein the plurality of linear heat lamps comprises at least one lamp disposed in a direction substantially perpendicular to at least one other lamp.

9. The semiconductor apparatus of claim 8, wherein said at least one lamp and said at least one other lamp are both oriented in a plane that is substantially parallel to the substrate holder.

10. The semiconductor apparatus of claim 1, wherein the plurality of linear heat lamps is disposed substantially in a single plane.

11. The semiconductor apparatus of claim 1, wherein the substrate holder further comprises a substantially circular pocket configured to receive the substrate, each of said lengths of said lamps being shorter than a diameter of the pocket.

12. The semiconductor apparatus of claim 1, wherein each lamp has a first and second end, the plurality of linear heat lamps comprising at least one lamp having its first and second ends both disposed either directly above or directly below the substrate holder so that neither of said ends extends beyond a lateral perimeter of the substrate holder.

13. A semiconductor apparatus comprising:
a substrate holder configured to support a semiconductor substrate during semiconductor processing; and
a plurality of linear heat lamps, the plurality being positioned either above or below the substrate holder, each lamp having approximately a first, second, or third length, the second length being between 40% and 60% of the first length, the third length being between 15% and 35% of the first length.

14. The semiconductor apparatus of claim 13, wherein the second length is approximately half the first length and the third length is approximately half the second length.

15. The semiconductor apparatus of claim 13, wherein the plurality of linear heat lamps comprises at least one lamp disposed in a direction non-parallel to at least one other lamp.

16. The semiconductor apparatus of claim 13, wherein the plurality of linear heat lamps comprises at least one lamp having first and second ends both disposed either directly above or directly below the substrate holder so that neither of said ends extends beyond a lateral perimeter of the substrate holder.

17. An array of heat lamps for providing radiant heat to a substrate being processed, said array comprising:
a first set of linear lamps each having approximately a first length;
a second set of linear lamps each having approximately a second length that is between 40-60% of the first length; and
a third set of linear lamps each having approximately a third length that is between 15-35% of the first length.

18. The array of heat lamps of claim 17, wherein the second length is approximately half the first length and the third length is approximately half the second length.

19. (canceled)

20. The array of heat lamps of claim 17, wherein at least one of said lamps is non-parallel with respect to another of said lamps.

21. A method comprising:
providing a substantially circular substrate holder configured to support a semiconductor substrate during semiconductor processing,
providing a plurality of linear heat lamps of a plurality of different lengths, each of the lengths being shorter than a diameter of the substrate holder; and
positioning the entire plurality of lamps either above or below the substrate holder.

22. The method of claim 21, wherein the plurality of different lengths comprises at least a first and second length, the second length being approximately half the first length.

23. The method of claim 21, further comprising arranging the lamps so that at least one of the lamps is disposed in a direction non-parallel to at least one other lamp.

24. The method of claim 21, wherein said plurality of lamps is a first plurality of lamps, the method further comprising:
providing a second plurality of linear heat lamps of a plurality of different lengths, each of the lengths of the second plurality being shorter than a diameter of the substrate holder; and
positioning the entire second plurality of lamps either above or below the substrate holder, such that the substrate holder is between the first and second pluralities of lamps.

25. The method of claim 21, further comprising:
supporting a semiconductor substrate on the substrate holder;
supplying power to the lamps to heat the substrate holder and the substrate; and
varying the power among the lamps to achieve a substantially uniform temperature across the substrate.

26. A method comprising:
providing a substrate holder configured to support a semiconductor substrate during semiconductor processing;
providing a plurality of linear heat lamps, each lamp having approximately a first, second, or third length, the second length being less than 60% of the first length, the third length being less than 60% of the second length; and
positioning the plurality of lamps either above or below the substrate holder.

27. The method of claim 26, further comprising arranging the lamps so that at least one of the lamps is disposed in a direction non-parallel to at least one other lamp.

28. The method of claim 26, further comprising:
supplying power to the lamps to heat the substrate holder and the substrate; and
varying the power among the lamps to achieve a substantially uniform temperature across the substrate.

29-31. (canceled)
